(19) United States
(12) Patent Application Publication
(10) Pub. No.: US 2012/0121091 A1
(43) Pub. Date: May 17, 2012

(54) AMBIENCE CODING AND DECODING FOR AUDIO APPLICATIONS

(75) Inventor: Juha Petteri Ojanpera, Nokia (FI)

(73) Assignee: NOKIA CORPORATION, Espoo (FI)

(21) Appl. No.: 13/201,612

(22) PCT Filed: Feb. 13, 2009
(86) PCT No.: PCT/EP09/51733

§ 371 Date: Jan. 23, 2012

(51) Int. Cl. H04R 5/00; G01S 3/80

(52) U.S. Cl. 381/2; 381/1; 367/124; 367/126

(57) ABSTRACT

A method comprising determining at least one first parameter, wherein the first parameter is dependent on a difference between at least two audio signals; determining at least one second parameter, wherein the second parameter is dependent on at least one directional component of the at least two signals; and generating at least one ambience coefficient value dependent on the at least one first parameter and the at least one second parameter.

The present invention relates to apparatus for the processing of audio signals. The invention further relates to, but is not limited to, apparatus for processing audio signals in mobile devices.

Spatial audio processing is the effect of an audio signal emanating from an audio source arriving at the left and right ears of a listener via different propagation paths. An auditory scene therefore may be viewed as the net effect of simultaneously hearing audio signals generated by one or more audio sources located at various positions relative to the listener.

Recently, spatial audio techniques have been used in connection with multi-channel audio reproduction. The objective of multichannel audio reproduction is to provide for efficient coding of multi channel audio signals comprising a plurality of separate audio channels or sound sources. Recent approaches to the coding of multichannel audio signals have centred on the methods of parametric stereo (PS) and Binaural Cue Coding (BCC). BCC typically encodes the multi-channel audio signal by down mixing the input audio signals into either a single (“sum”) channel or a smaller number of channels conveying the “sum” signal. In parallel, the most salient inter channel cues, otherwise known as spatial cues, describing the multi-channel sound image or audio scene are extracted from the input channels and coded as side information. Both the sum signal and side information form the encoded parameter set which can then either be transmitted as part of a communication chain or stored in a store and forward type device. Most implementations of the BCC technique typically employ a low bit rate audio coding scheme to further encode the sum signal. Finally, the BCC decoder generates a multi-channel output signal from the transmitted or stored sum signal and spatial cue information. Typically down mix signals employed in spatial audio coding systems are additionally encoded using low bit rate perceptual audio coding techniques such as AAC (Advanced Audio Coding) to further reduce the required bit rate.

In these low and medium bit rate stereo extension decoding systems, the stereo image is thus coded as an extension with respect to the mono-signal. Typically a high bit rate is used for coding the mono-signal and a small fraction of the total bit rate for the stereo image encoding. The decoded down mixed signal is then up mixed back to stereo using the stereo extension information in the receiver or decoder.

As described above, the stereo extension information typically is parametrically coded audio scene parameters such as ICLD (inter channel level delay), ICC (inter channel correlation) and ICD (inter channel time delay). However, these parameters are not able to reconstruct the ambience (in other words the feeling of the audio space) of the decoded signal to user expected levels at the bitrates typically used.

For example, multiple stream stereo and coding based on the difference signal between the left and right channels (or the difference between channel pairs in multichannel systems) is typically coded on a frequency band basis using psycho acoustical information and indicates the amount of quantization noise that can be introduced to each band without the output producing appreciable audio degradation. In other words the encoding process focuses only upon making the noise image band inaudible rather than encoding the audio signal with suitable ambience experience.

There is provided according to the invention a method comprising: determining at least one first parameter, wherein the first parameter is dependent on a difference between at least two audio signals; determining at least one second parameter, wherein the second parameter is dependent on at least one directional component of the at least two signals; and generating at least one ambience coefficient value dependent on the at least one first parameter and the at least one second parameter.

Thus in embodiments of the invention ambience coefficient values may be determined to allow a suitable ambience experience to be recreated with the audio signal.

Determining the first at least one parameter may comprise determining at least one of: an inter channel level difference; an inter channel time delay; and an inter channel correlation.

Each at least one second parameter is preferably a direction vector relative to a defined listening position for each of at least one frequency range for a combination of a first and a second of the at least two audio signals.

Generating the ambience coefficient value may comprise: determining that each direction vector is directed towards a first predefined direction wherein the ambience coefficient value associated with each direction vector is equal to an associated first parameter.

Generating the ambience coefficient value may comprises: determining that the distribution of all direction vectors is throughout the range from a first predefined direction to a second predefined direction and at least one direction vector is directed generally towards the first predefined direction and a further direction vector is directed generally towards the second predefined direction; grouping the direction vectors into neighbouring direction vector clusters; and ranking the clusters dependent on the distance between direction vectors in each cluster; wherein the ambience coefficient value associated with at least the highest ranked cluster of direction vectors is equal to an associated first parameter.

The method may further comprise: generating a sum signal of the combined first and second audio signals.

The method may further comprise: generating a stereo signal of the combined first and second audio signals.

The method may further comprise: multiplexing the sum signal, stereo signal and the at least one ambience coefficient.

According to a second aspect of the invention there is provided a method comprising: receiving an encoded audio signal, the audio signal comprising: at least one mono audio signal value, and at least one ambience coefficient value; and generating a first audio signal wherein the first audio signal is a combination of the mono audio signal value with an associated stereo audio signal value if an associated ambience coefficient value is zero, and a combination of the mono audio signal value with the associated ambience coefficient value if the associated ambience coefficient value is non-zero.

The method may further comprise: generating a second audio signal wherein the second audio signal is a difference of the mono audio signal value with an associated stereo audio signal value if an associated ambience coefficient value is zero, and a difference of the mono audio signal value with the associated ambience coefficient value if the associated ambience coefficient value is non-zero.

According to a third aspect of the invention there is provided an apparatus comprising a processor configured to: determine at least one first parameter, wherein the first parameter is dependent on a difference between at least two audio signals; determine at least one second parameter, wherein the second parameter is dependent on at least one directional component of the at least two signals; and generate at least one ambience coefficient value dependent on the at least one first parameter and the at least one second parameter.

The at least one parameter may comprise: an inter channel level difference; an inter channel time delay; and an inter channel correlation.

Each at least one second parameter is preferably a direction vector relative to a defined listening position for each of at least one frequency range for a combination of a first and a second of the at least two audio signals.

The apparatus may be further configured to: determine that each direction vector is directed towards a first predefined direction wherein the ambience coefficient value associated with each direction vector is equal to an associated first parameter.

The apparatus may be further configured to: determine that the distribution of all direction vectors is throughout the range from a first predefined direction to a second predefined direction and at least one direction vector is directed generally towards the first predefined direction and a further direction vector is directed generally towards the second predefined direction; group the direction vectors into neighbouring direction vector clusters; and rank the clusters dependent on the distance between direction vectors in each cluster; wherein the ambience coefficient value associated with at least the highest ranked cluster of direction vectors is equal to an associated first parameter.

The apparatus may be further configured to: generate a sum signal of the combined first and second audio signals.

The apparatus may be further configured to: generate a stereo signal of the combined first and second audio signals.

The apparatus may be further configured to: multiplex the sum signal, stereo signal and the at least one ambience coefficient.

According to a fourth aspect of the invention there is provided an apparatus comprising a processor configured to: receive an encoded audio signal, the audio signal comprising: at least one mono audio signal value and at least one ambience coefficient value; and generate a first audio signal wherein the first audio signal is a combination of the mono audio signal value with an associated stereo audio signal value if an associated ambience coefficient value is zero, and a combination of the mono audio signal value with the associated ambience coefficient value if the associated ambience coefficient value is non-zero.

The apparatus may be further configured to: generate a second audio signal wherein the second audio signal is a difference of the mono audio signal value with an associated stereo audio signal value if an associated ambience coefficient value is zero, and a difference of the mono audio signal value with the associated ambience coefficient value if the associated ambience coefficient value is non-zero.

According to a fifth aspect of the invention there is provided a computer-readable medium encoded with instructions that, when executed by a computer, perform: determining at least one first parameter, wherein the first parameter is dependent on a difference between at least two audio signals; and determining at least one second parameter, wherein the second parameter is dependent on at least one directional component of the at least two signals; generate at least one ambience coefficient value dependent on the at least one first parameter and the at least one second parameter.

According to a sixth aspect of the invention there is provided a computer-readable medium encoded with instructions that, when executed by a computer, perform: receiving an encoded audio signal, the audio signal comprising: at least one mono audio signal value and at least one ambience coefficient value; and generating a first audio signal wherein the first audio signal is a combination of the mono audio signal value with an associated stereo audio signal value if an associated ambience coefficient value is zero, and a combination of the mono audio signal value with the associated ambience coefficient value if the associated ambience coefficient value is non-zero.

According to a seventh aspect of the invention there is provided an apparatus comprising: means for determining at least one first parameter, wherein the first parameter is dependent on a difference between at least two audio signals; means for determining at least one second parameter, wherein the second parameter is dependent on at least one directional component of the at least two signals; and means for generating at least one ambience coefficient value dependent on the at least one first parameter and the at least one second parameter.

According to an eighth aspect of the invention there is provided an apparatus comprising: means for receiving an encoded audio signal, the audio signal comprising: at least one mono audio signal value and at least one ambience coefficient value; and means for generating a first audio signal wherein the first audio signal is a combination of the mono audio signal value with an associated stereo audio signal value if an associated ambience coefficient value is zero, and a combination of the mono audio signal value with the associated ambience coefficient value if the associated ambience coefficient value is non-zero.

The apparatus as described above may comprise an encoder.

The apparatus as described above may comprise a decoder.

An electronic device may comprise apparatus as described above.

A chipset may comprise apparatus as described above.

Embodiments of the present invention aim to address the above problem.

For better understanding of the present invention, reference will now be made by way of example to the accompanying drawings in which:

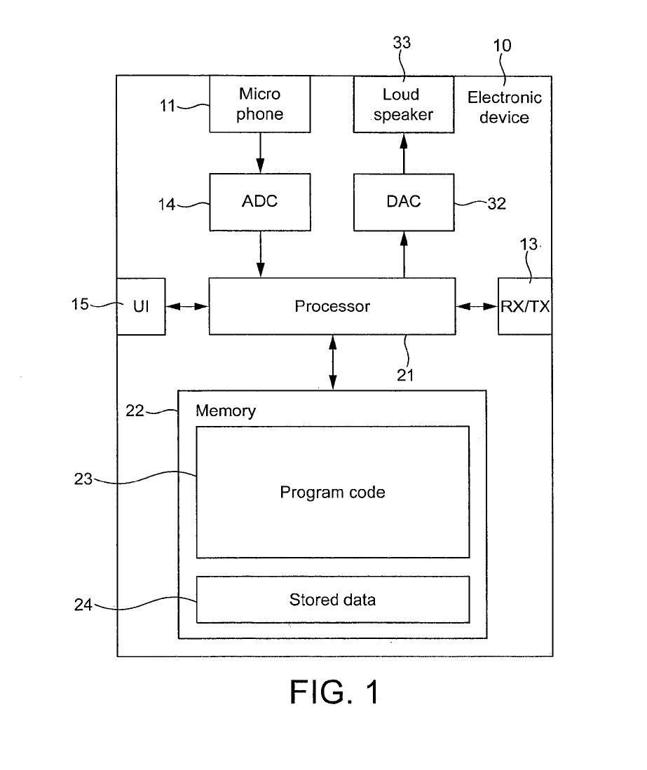

FIG. 1 shows schematically an electronic device employing embodiments of the invention;

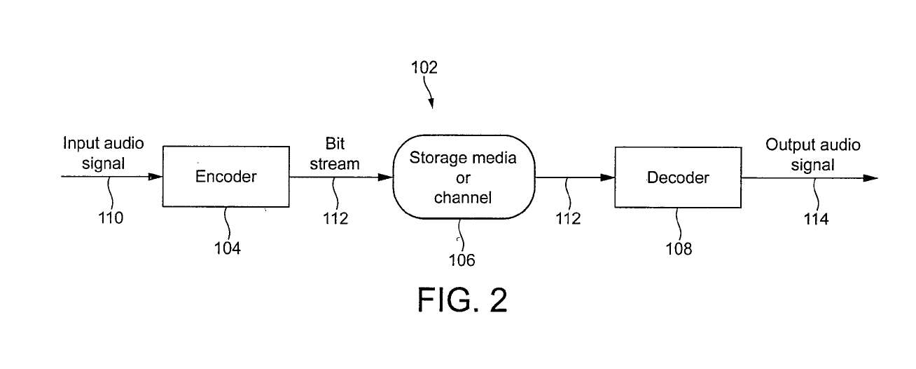

FIG. 2 shows schematically an audio processing system employing embodiments of the present invention;

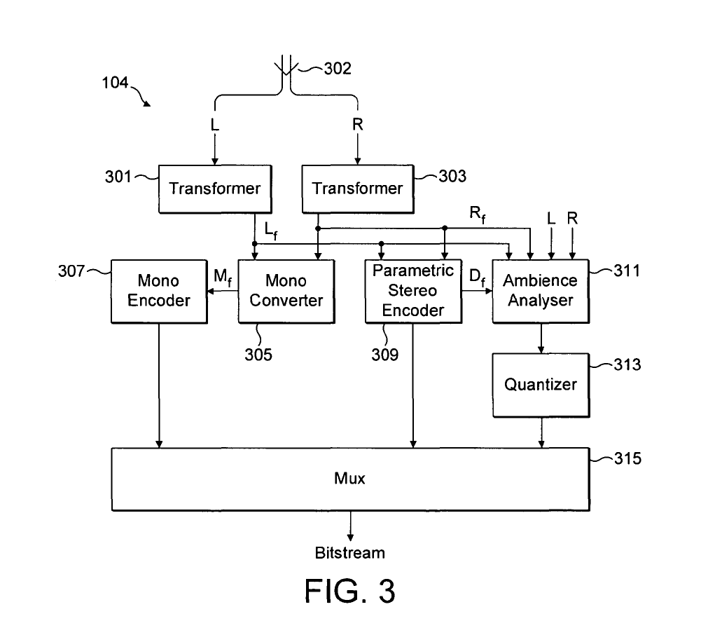

FIG. 3 shows schematically an encoder as shown in FIG. 2 according to a first embodiment of the invention;

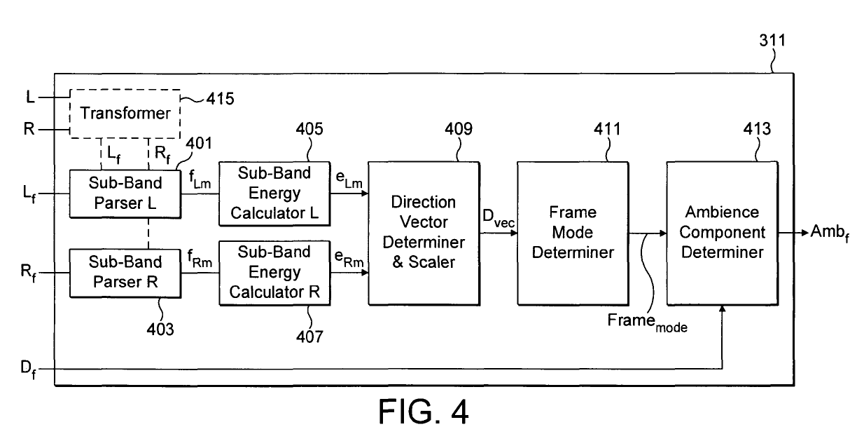

FIG. 4 shows schematically an ambience analyzer as shown in FIG. 3 according to a first embodiment of the invention;

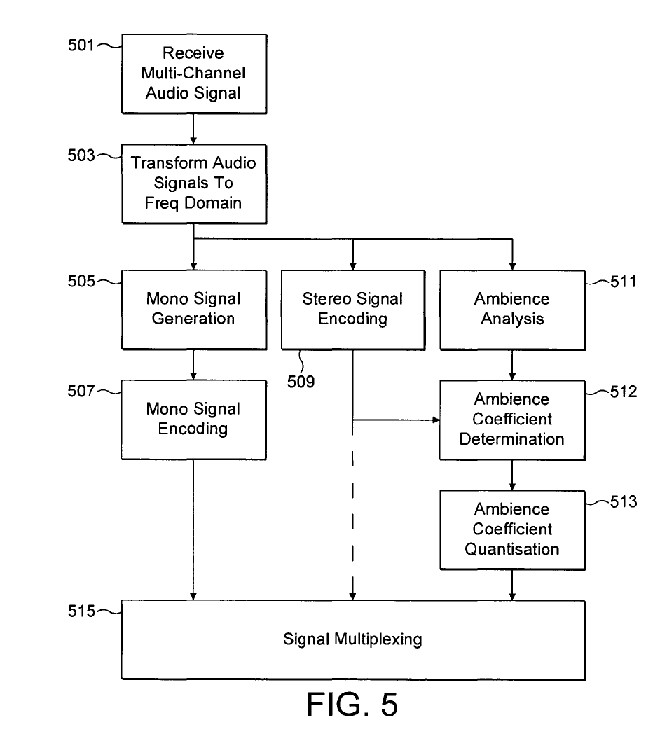

FIG. 5 shows a flow diagram illustrating the operation of the encoder according to embodiments of the invention;

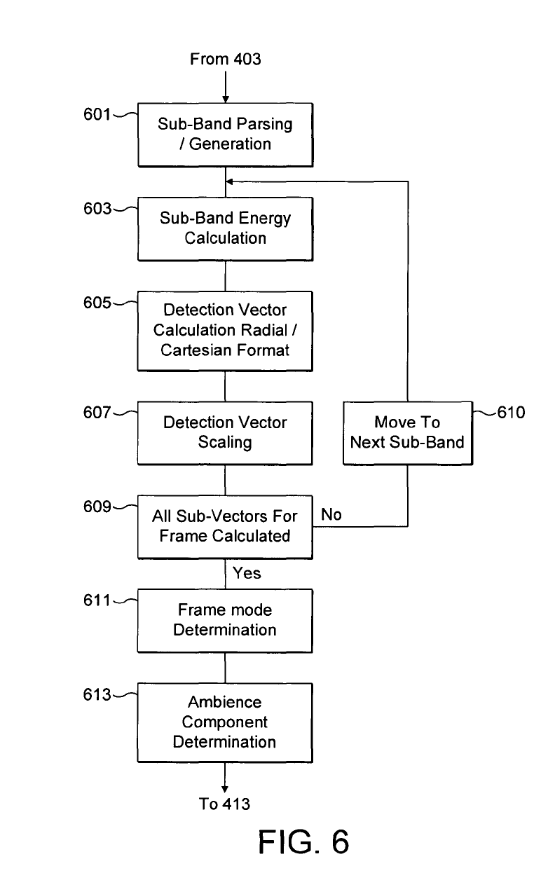

FIG. 6 shows a flow diagram illustrating the operation of the ambience analyzer according to embodiments of the invention;

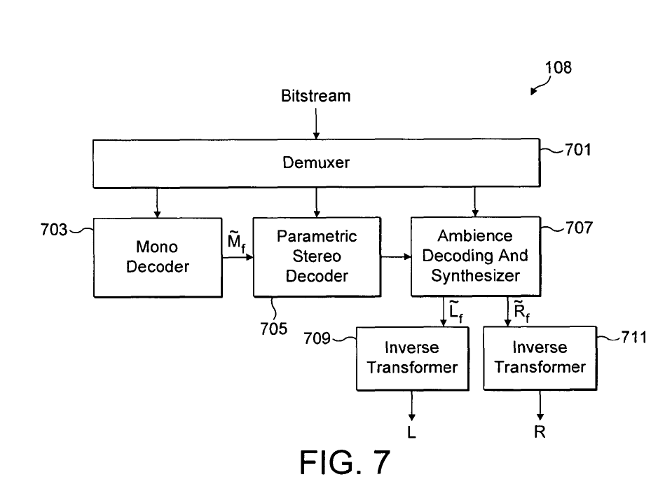

FIG. 7 shows schematically a decoder as shown in FIG. 2 according to a first embodiment of the invention;

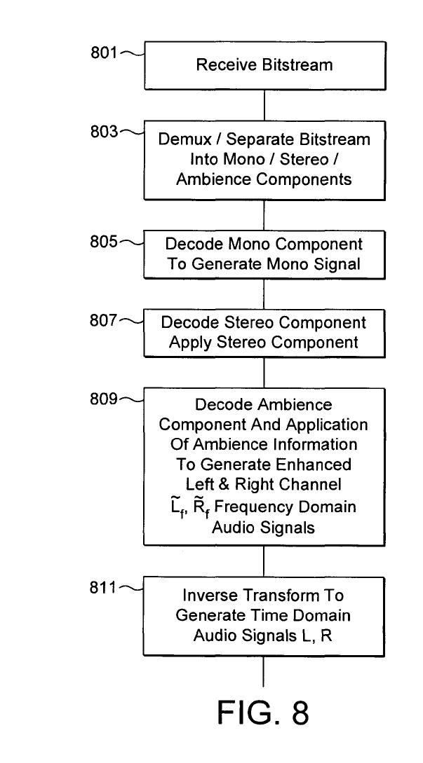

FIG. 8 shows a flow diagram illustrating the operation of the decoder as shown in FIG. 7 according to embodiments of the invention;

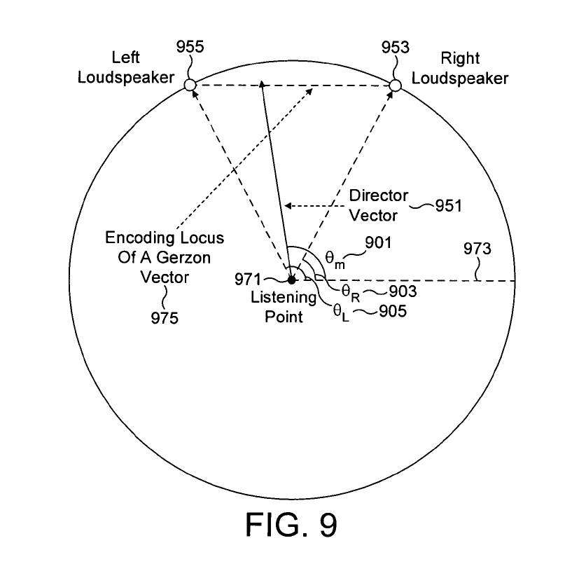

FIG. 9 shows schematically a vector diagram with the director vector shown with respect to the left and right loudspeaker vectors; and

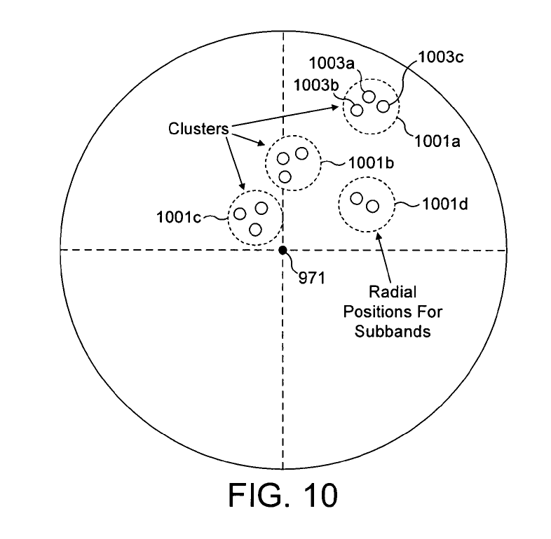

FIG. 10 shows schematically the clustering of sub-band director vectors according to embodiments of the invention.

The following describes in further detail suitable apparatus and possible mechanisms for the provision of enhancing encoding efficiency and signal fidelity for an audio codec. In this regard reference is first made to FIG. 1 which shows a schematic block diagram of an exemplary apparatus or electronic device 10, which may incorporate a codec according to an embodiment of the invention.

The electronic device 10 may for example be a mobile terminal or user equipment of a wireless communication system.

The electronic device 10 comprises a microphone 11, which is linked via an analogue-to-digital converter (ADC) 14 to a processor 21. The processor 21 is further linked via a digital-to-analogue (DAC) converter 32 to loudspeakers 33. The processor 21 is further linked to a transceiver (TX/RX) 13, to a user interface (UI) 15 and to a memory 22.

The processor 21 may be configured to execute various program codes. The implemented program codes may comprise encoding code routines. The implemented program codes 23 may further comprise an audio decoding code. The implemented program codes 23 may be stored for example in the memory 22 for retrieval by the processor 21 whenever needed. The memory 22 may further provide a section 24 for storing data, for example data that has been encoded in accordance with the invention.

The encoding and decoding code may in embodiments of the invention be implemented in hardware or firmware.

The user interface 15 may enable a user to input commands to the electronic device 10, for example via a keypad, and/or to obtain information from the electronic device 10, for example via a display. The transceiver 13 enables a communication with other electronic devices, for example via a wireless communication network. The transceiver 13 may in some embodiments of the invention be configured to communicate to other electronic devices by a wired connection.

It is to be understood again that the structure of the electronic device 10 could be supplemented and varied in many ways.

A user of the electronic device 10 may use the microphone 11 for inputting speech that is to be transmitted to some other electronic device or that is to be stored in the data section 24 of the memory 22. A corresponding application has been activated to this end by the user via the user interface 15. This application, which may be run by the processor 21, causes the processor 21 to execute the encoding code stored in the memory 22.

The analogue-to-digital converter 14 may convert the input analogue audio signal into a digital audio signal and provides the digital audio signal to the processor 21.

The processor 21 may then process the digital audio signal in the same way as described with reference to the description hereafter.

The resulting bit stream is provided to the transceiver 13 for transmission to another electronic device. Alternatively, the coded data could be stored in the data section 24 of the memory 22, for instance for a later transmission or for a later presentation by the same electronic device 10.

The electronic device 10 may also receive a bit stream with correspondingly encoded data from another electronic device via the transceiver 13. In this case, the processor 21 may execute the decoding program code stored in the memory 22. The processor 21 may therefore decode the received data, and provide the decoded data to the digital-to-analogue converter 32. The digital-to-analogue converter 32 may convert the digital decoded data into analogue audio data and outputs the analogue signal to the loudspeakers 33. Execution of the decoding program code could be triggered as well by an application that has been called by the user via the user interface 15.

The received encoded data could also be stored instead of an immediate presentation via the loudspeakers 33 in the data section 24 of the memory 22, for instance for enabling a later presentation or a forwarding to still another electronic device.

In some embodiments of the invention the loudspeakers 33 may be supplemented with or replaced by a headphone set which may communicate to the electronic device 10 or apparatus wirelessly, for example by a Bluetooth profile to communicate via the transceiver 13, or using a conventional wired connection.

It would be appreciated that the schematic structures described in FIGS. 3, 4 and 7 and the method steps in FIGS. 5, 6 and 8 represent only a part of the operation of a complete audio codec as implemented in the electronic device shown in FIG. 1.

The general operation of audio codecs as employed by embodiments of the invention is shown in FIG. 2. General audio coding/decoding systems consist of an encoder and a decoder, as illustrated schematically in FIG. 2. Illustrated is a system 102 with an encoder 104, a storage or media channel 106 and a decoder 108.

The encoder 104 compresses an input audio signal 110 producing a bit stream 112, which is either stored or transmitted through a media channel 106. The bit stream 112 can be received within the decoder 108. The decoder 108 decompresses the bit stream 112 and produces an output audio signal 114. The bit rate of the bit stream 112 and the quality of the output audio signal 114 in relation to the input signal 110 are the main features, which define the performance of the coding system 102.

FIG. 3 shows schematically an encoder 104 according to a first embodiment of the invention. FIG. 5 shows a flow chart of the encoder operation according to an embodiment of the invention. The encoder 104 is depicted receiving an input 302 divided into two channels. The two channels for the example depicted are a left channel L and a right channel R. In the following description of both the encoder and the decoder the audio input (and therefore the audio output) is a 2 channel (Left and Right channel) system, however it would be understood that embodiments of the invention may have more than 2 input channels. Any embodiments with more than 2 input channels may for example be considered to be two or more embodiments of 2 input channel apparatus (or sub-systems) as described in the exemplary embodiments below. Thus for example a three channel input may be divided into a first sub-system with the first and third channels and a second sub-system with the first and second channels. Although the below description refers to a left and right channel it may be understood that this may represent any first selected channel and any second selected audio channel

In a first embodiment of the invention, each channel of the audio signal is a digitally sampled signal. In other embodiments of the present invention, the audio input may be an analogue audio signal, for example from a microphone 11 as shown in FIG. 1, which is then analogue-to-digitally (A/D) converted. In further embodiments of the invention, the audio signal may be converted from a pulse-code modulation digital signal to amplitude modulation digital signal.

Each channel of the audio signal may represent in embodiments of the invention the audio signal sampled at a specific location or in other embodiments is a synthetically generated audio signal representing the expected audio signal at a specific position.

The reception of the multi-channel input audio signal, which for this embodiment is a two channel audio input, is shown in step 401.

The left channel audio signal input L is input to the left time to frequency domain transformer 301. The right channel audio signal input R is input to the right time to frequency domain transformer 303.

The time to frequency domain transformer in embodiments of the invention is a modified discrete cosine transformer (MDCT) which outputs a series of frequency component values representing the activity of the signal for a specific frequency interval over a predetermined time (or frame) period. In other embodiments of the invention, the time to frequency domain transformer may be a discrete Fourier transformer (DFT), a modified discrete sine transformer (MDST), or a filter bank structure which include but are not limited to quadrature mirror filter banks (QMF) and cosine modulated pseudo QMF filter banks or any other transform which provides a suitable frequency domain representation of a time domain signal.

The left time to frequency domain transformer 301 may thus receive the left channel audio signal L and outputs left channel frequency domain values L_{f}, which are output to the mono-converter 305, the parametric stereo encoder 309, and the ambience analyser 311. The right channel time to frequency domain transformer 303 similarly may receive the right channel audio signal R and output the right channel frequency domain values R_{f}, to the mono-converter 305, the parametric stereo encoder 309, and the ambience analyser 311.

The transformation of the audio signals to the frequency domain is shown in FIG. 5 by step 403.

The mono-converter 305 receives the frequency domain signals for the left channel L_{f} and the right channel R_{f}. The mono converter 305 may in embodiments of the invention, produce the mono frequency domain audio signal M_{f} by combining the left and right channel frequency domain audio signals values according to the below equation:

M_{f}=0.5·(L_{f}+R_{f}).

The mono frequency domain audio signal values M_{f} may be output to the mono-encoder 307.

The operation of generating the mono-signal is shown in FIG. 5 by step 505.

The mono encoder 307, having received the mono frequency domain audio signal M_{f} then performs a mono frequency domain audio signal encoding operation. The mono-encoding operation may be any suitable mono-frequency domain coding scheme. For example, the mono encoding may encode frequency domain values using the advanced audio coding (AAC) encoding process such as defined in ISO/IEC 13818-7:2003, or the AAC+ encoding process defined in ISO/IEC 14496-3:2005. Further encoding operations in other embodiments of the invention may be the use of algebraic code excited linear prediction (ACELP) encoding, or for example using the newly issued ITU-T G.718 mono-codec. The ITU-T G.718 mono codec employs an underlying algorithm based on a two-stage coding structure: the lower two layers are based on Code-Excited Linear Prediction (CELP) coding of the band (50-6400 Hz) where the core layer takes advantage of signal-classification to use optimized coding modes for each frame. The higher layers encode the weighted error signal from the lower layers using overlap-add the modified discrete cosine transform (MDCT) transform values. The encoded mono-signal is output from the mono-encoder 307 to the multiplexer 315. The encoding of the mono signal may in some embodiments of the invention further include a quantization operation.

The operation of encoding the mono signal is shown in FIG. 5 by step 407.

The parametric stereo encoder 309, having received the left channel L_{f} and the right channel R_{f} frequency domain values, determines the stereo characteristics of the audio signal channels and also encodes these characteristics. In some embodiments of the invention the stereo characteristics of the audio signals are represented by the difference (or a scaled difference value) between the left and right channel frequency components. The inter channel level difference (ICD) parameter D_{f} may be represented in some embodiments of the invention by the following equation:

D_{f}=0.5·(L_{f}−R_{f}).

In further embodiments of the invention the stereo characteristics of the audio signal channel values may include parameters representing other differences between the left and right channel values. These difference values may be for example the inter channel time delay value (ICTD) which represents the time difference or phase shift of the signal between the two channels. Furthermore in other embodiments of the invention, the parametric stereo encoder may generate further parameters from the left and right channels such as the inter channel correlation (ICC) parameter. The ICC may be determined to be the maximum of the normalised correlation between the two channels for different values of delay between the signals. The ICC may be related to the perceived width of the audio's source, so that if an audio source is perceived to be wide then the corresponding coherence between the left and right channels may be lower when compared to an audio source which is perceived to be narrow. For example, the coherence of a binaural signal corresponding to an orchestra may be typically lower than the coherence of a binaural signal corresponding to a single violin. Therefore in general an audio signal with a lower coherence may be perceived to be more spread out in the auditory space.

In some embodiments of the invention, the parametric stereo encoder 309 further quantizes the characteristic parameter values. The quantization process may be any suitable quantization procedure. In these embodiments the quantized parameter values are output otherwise unquantized parameter values are output.

The output of the parametric stereo encoder 309 is passed to the ambience analyser 311. In other embodiments of the invention the output of the parametric stereo encoder 309 may be passed to the multiplexer 315.

The operation of stereo signal encoding is shown in FIG. 5 by step 509.

The ambience analyser 311 receives the left channel frequency component L_{f} and the right channel frequency component R_{f}. In some embodiments of the invention the ambience analyser may receive the left and right channel audio signals in time domain form directly separately or in some embodiments of the invention the ambience analyser 311 may receive both the frequency domain and the time domain left and right channel values. In some embodiments of the invention the characteristic parameter values may be also received by the ambience analyser 311.

The ambience analyser 311 is configured to receive the left and right channel audio signals and generate suitable ambience parameters representing the ambience of the audio signals.

An embodiment of the ambience analyser 311 is shown schematically in further detail in FIG. 4, and the operation of the ambience analyser shown in a flow diagram shown in FIG. 6.

The embodiments shown in FIGS. 4 and 6 and described in detail below are those where the output of the left time to frequency domain transformer 301 and the right time to frequency domain transformer 303 output complex frequency domain components. In embodiments where the output of the left time to frequency domain transformer 301 and the right time to frequency domain transformer 303 are real values or imaginary values only, the optional time to frequency domain transformer 415 may be used to enable the ambience analyser 311 to perform the analysis on complex values of the frequency domain audio signal. For example where the left time to frequency domain transformer 301 and the right time to frequency domain transformer 303 are modified cosine fourier transformers outputting real values only the time to frequency domain transformer may output the relevant values—for example either supplementary imaginary values or substitute complex frequency domain values such as those produced by a fast fourier transform (FFT), a modified discrete sine transformer (MDST), discrete fourier transformer (DFT) or complex value output quadrature mirror filter (QMF).

The ambience analyser 311 receives the complex valued left and right channel frequency domain values for each frame. The left channel complex frequency domain values are input to a left sub-band parser 401, and the right channel complex frequency domain values are input to a right sub-band parser 403.

Each of the left and right sub-band parsers 401, 403 divide or group the received values (L_{f} and R_{f}) into frequency sub-bands (f_{Lm} the left channel complex frequency components for the m'th sub-band and f_{Rm}, the right channel complex frequency components for the m'th sub-band) for further processing. This grouping of the values into sub-band groups may be regular or irregular.

In some embodiments of the invention the grouping of the values into sub-bands may be made based on the knowledge of the human auditory system, and thus be organised to divide the values into sub-bands on a pseudo-logarithmic scale so that the sub-band more closely reflect the auditory sensitivity of the human ear.

To assist in the understanding of the invention the number of sub-bands into which the frame frequency domain values for each of the left and the right channels are divided is M.

In the embodiments described hereafter the sub-bands are analysed one at a time in that a first sub-band of frequency component values are processed and then a second sub-band of frequency component values are then processed. However it would be understood that the following analysis operations may be performed upon each sub-band concurrently or in parallel. Similarly the processing of the left and right channel values has been shown to be carried out in parallel in that there are two sub-band parsers, two time to frequency domain transformers. However it would be appreciated that the processing of one channel followed by the processing of the second channel may be carried out by in series, for example by processing the left and right channel values alternately.

The left sub-band parser 401 may then pass the left channel frequency domain values f_{Lm} for a sub-band (m) to a left channel sub-band energy calculator 405. The left sub-band parser 403 may then pass the right channel frequency domain values f_{Rm} for the sub-band (m) may then be passed to a right channel sub-band energy calculator 407.

The sub-band parsing/generation operation is shown in FIG. 6 by step 601.

The left channel sub-band energy calculator 405 receives the left channel m'th sub-band frequency component values and outputs the energy value of the m'th sub-band for the left channel frequency components. The right channel sub-band energy calculator 407 receives the right channel m'th sub-band frequency component values and outputs the energy value of the m'th sub-band for the right channel frequency components. The left channel and right channel sub-band energy values may be calculated according to the following equations:

$${e}_{{L}_{m}} = \sqrt{{\sum }_{j = sbOffset [ m ]}^{sbOffset [ m + 1 ] - 1} {\vert {\overline{f}}_{L} ( j ) \vert}^{2}} , {e}_{{R}_{m}} = \sqrt{{\sum }_{j = sbOffset [ m ]}^{sbOffset [ m + 1 ] - 1} {\vert {\overline{f}}_{R} ( j ) \vert}^{2}} ,$$

where f̅_{L}(j) and f̅_{R} (j) are the left channel and right channel respectively j'th complex frequency domain value, and sbOffset(m) to sbOffset(m+1)−1 defines the indices for the values of the m'th sub-band.

The left channel sub-band energy calculator 405 outputs the left channel sub-band energy value e_{Lm} to the direction vector determiner and scaler 409. Similarly the right channel sub-band energy calculator 407 outputs the right channel sub-band energy value e_{Rm} to the direction vector determiner and scaler 409

The calculation of the sub-band energy value is shown in FIG. 6 by step 603.

The direction vector determiner and scaler 409 receives the energy values for the left and the right channels e_{Lm} and e_{Rm} respectively. In embodiments of the invention a gerzon vector is defined dependent on the values of the left channel and right channel energy values and the directions of the left channel loudspeaker and the right channel loudspeaker from the reference position of the listening point. For example in an embodiment of the invention the real and imaginary components of the gerzon vector may be defined as:

$${alfa\_r}_{m} = \frac{{e}_{{L}_{m}} \cdot cos ( {θ}_{L} ) + {e}_{{R}_{m}} \cdot cos ( {θ}_{R} )}{{e}_{{L}_{m}} + {e}_{{R}_{m}}} , \\ {alfa\_i}_{m} = \frac{{e}_{{L}_{m}} \cdot sin ( {θ}_{L} ) + {e}_{{R}_{m}} \cdot sin ( {θ}_{R} )}{{e}_{{L}_{m}} + {e}_{{R}_{m}}}$$

where alfa_rₘ and alfa_iₘ are the real and imaginary components of the gerzon vector for the m'th sub-band, θ_{L} and θ_{R} are the directions of the left and right channel loudspeakers with respect to the listening point respectively, and e_{Lm} and e_{Rm} are the energy values for the left and right channels for the m'th sub-band.

The gerzon vector and the angles θ_{L} and θ_{R} can be further demonstrated with respect to FIG. 9. FIG. 9 shows a series of vectors originating from the listening point 971 which have an angle measured with respect to a listening point reference vector 973. The listening point reference vector may be any suitable vector as both the left channel loudspeaker 955 angle θ_{L} 905 and the right channel loudspeaker 953 angle θ_{R} 903 are relative to the same reference vector. However in some embodiments of the invention the reference vector is a vector from the listening point parallel to the vector connecting the left loudspeaker and the right loudspeaker.

The values of θ_{L} and θ_{R} are known and may be defined by the encoder/decoder embodiment. Thus in an embodiment of the invention the separation of the loudspeakers may be configured so that θ_{L} is 120 degrees and θ_{R} is 60 degrees so that the left and right channel loudspeakers are equally angularly spaced about the listening point 971. However it would be appreciated that any suitable loudspeaker angles may by used. The value of θ_{L} is 120 degrees and θ_{R} is 60 degrees are the typical values used in stereo recordings. In some embodiments of the invention some control information may be passed to the encoding system from the capturing system (for example microphones receiving the original signal) if the θ_{L} and θ_{R} values differ greatly from the values predefined above. In further embodiments of the invention where the original capturing system differs significantly from the predefined values then the decoder (as will be described in further detail later) may also be signalled with the control information about the recording angles in the same manner as the encoder was signalled.

This gerzon vector calculation is shown in FIG. 6 by steps 605.

The detection vector determiner and scaler 409 may furthermore scale the gerzon vector for the sub-band such that the encoding locus extends to the unit circle. The gain values g₁ and g₂ for the radial length correction may be determined according to the following equation:

$${g}_{1} \cdot [ \begin{matrix}cos ( {θ}_{L} ) \\ sin ( {θ}_{L} )\end{matrix} ] + {g}_{2} \cdot [ \begin{matrix}cos ( {θ}_{R} ) \\ sin ( {θ}_{R} )\end{matrix} ] = [ \begin{matrix}{alfa\_r}_{m} \\ {alfa\_i}_{m}\end{matrix} ]$$

$$\overline{g} = {[ \begin{matrix}cos ( {θ}_{L} ) & cos ( {θ}_{R} ) \\ sin ( {θ}_{L} ) & sin ( {θ}_{R} )\end{matrix} ]}^{- 1} \cdot \overline{alfa} ,$$

and the gains are scaled to unit length vectors using the following equations:

$${G}_{1} = \frac{{g}_{1}}{\sqrt{{g}_{1}^{2} + {g}_{2}^{2}}} , {G}_{2} = \frac{{g}_{2}}{\sqrt{{g}_{1}^{2} + {g}_{2}^{2}}} .$$

Thus the direction vector determiner and scaler 409 outputs a scaled direction vector with real and imaginary components dVecᵣₑₘ and dVecᵢₘₘ:

dVecᵣₑₘ=alfa_{—}rₘ·G₁, dVecᵢₘₘ=alfa_{—}iₘ·G₂

The operation of scaling the direction vector is shown in FIG. 6 by step 607.

The ambience analyser 311 then determines whether or not all of the sub-bands for the frame have been analysed. The step of checking whether or not all of the sub-bands have been analysed is shown in FIG. 6 by step 609.

If there are some sub-bands remaining to be analysed for the frame, the operation passes to the next sub-band as shown in step 610 of FIG. 6 and then the next sub-band is analysed by determining the sub-band energy values, the gerzon vector and the direction vectors, in other words, the process passes back to step 603. If all of the sub-bands for the frame have been analysed, then the direction vectors which have been determined and scaled are passed to the frame mode determiner 411.

The frame mode determiner 411, receives the sub-band direction vectors for all of the sub-bands for a frame and determines the frame mode of the frame. In some embodiments of the invention there may be defined two modes. A first mode may be called the normal mode—where the sub-band direction vectors are distributed on both the left and right channel sides. An orchestra may for example produce such a result as each sub-band direction vector (representing the audio energy for a group of frequencies would not be only on the left or the right side but would be located across the range from the left to the right channel. A second mode may be called the panning mode. In the panning mode the sub-band direction vectors are distributed only on one or the other channel side. A vehicle which at the far left channel or the far right channel may produce such a result as the majority of the audio energy is located at the left or right channel positions.

A first method for determining the frame mode may be to follow the following operations.

Firstly the frame mode determiner 411 may initialise a left count (ICount) and right count (rCount) index. Furthermore initialise a left indicator (aL) and a right indicator value (aR).

Then the frame mode determiner 411 may determine for each sub-band direction vector if the direction vector is directed to the right channel or the left channel.

Where the sub-band direction vector is more directed to the right channel then the frame mode determiner 411 may determine and store the difference angle (dR) between the direction vector and the bisection of the left channel and the right channel (which for a symmetrical system where the reference vector is parallel to the vector between the left channel loudspeaker and the right channel loudspeaker is 90 degrees) and may also calculate and store a running total of all of the right channel difference angles (aR).

Similarly where the sub-band direction vector is more directed to the left channel then the frame mode determiner 411 may determine and store the difference angle (dL) between the direction vector and the bisection of the left channel and the right channel and also may also determine and store a running total of all of the difference angles (aL).

The frame mode determiner 411 may determine the average left and right difference angles (AvaL, AvaR).

The above processes may be summarised in pseudo code as shown below

```
    lCount = 0; rCount = 0
    aL = 1E-15; aR = 1E-15
    for(m = 0; m < M; m++)
    {
      if (θₘ < 90°)
      {
        dR[rCount++] = |90° − θₘ|
        aR += |90° − θₘ|
      }
      Else
      {
        dL [lCount++] = |90° − θₘ|
        aL += |90° − θₘ|
      }
    }
          $AvaL = \frac{aL}{MAX ( lCount , 1 )} , AvaR = \frac{aR}{MAX ( rCount , 1 )}$
        where MAX returns the maximum of the specified values.
```

The frame mode determiner 411 may determine whether the mode is a panning mode where there is:

Firstly either all left or all right channel deviations; and
Secondly the average left or right channel deviation angle is greater than a predefined angle (for example 5 degrees); and
Thirdly the greater of the average left or right channel deviation angle is a factor greater than the lesser average left or right channel deviation angle (for example that the greater value is twice as large as the lesser value).

This may be summarised by the following decision criteria:

$$frameMode = \{ \begin{matrix}des\_level \_ 2 , & \frac{MAX ( AvaL , AvaR )}{MIN ( AvaL , AvaR )} > 2.0 \\ normalMode , & otherwise\end{matrix} \\ des\_level \_ 2 = \{ \begin{matrix}panMode , & \begin{matrix}( lCount == 0 or rCount == 0 ) and \\ ( AvaL > 5.0 or AvaR > 5.0 )\end{matrix} \\ normalMode , & otherwise\end{matrix}$$

The frame mode determination value is then passed to the ambience component determiner 413 to determine the ambience component values.

The determination of the frame mode is shown in FIG. 6 by step 611.

The ambience component determiner 413 having received the frame mode and also having received the stereo parameter values may then determine the ambience component values. In the following examples the difference parameter D_{f} is used as an example of the stereo parameter value which may be modified in light of the frame mode and the ambience analysis to determine ambience coefficient values. However it would be appreciated that other stereo parametric values may be used either instead of or as well as the difference parameter.

In some embodiments of the invention having received the frame mode value indicating that the frame mode is in a panning mode the ambience component determiner 413 may determine the ambience components by following the process below.

For a first frame where the number of sub-bands with a direction vector to the left loudspeaker was greater than the number of sub-bands with a direction vector to the right loudspeaker a first set of values is generated. In these first set of values, where the sub-band direction vector was directed towards the left speaker the ambience component associated with that sub-band has the stereo difference value D_{f}, but where the sub-band direction vector was directed towards the right speaker the ambience component associated with the sub-band has a zero value. In other words the ambience component determiner filters out sub-band components where the sub-band is directed away from the dominant loudspeaker direction.

Similarly for a first frame where the number of sub-bands with a direction vector to the left loudspeaker was less than the number of sub-bands with a direction vector to the right loudspeaker a set of values is determined. The values associated with the sub-bands have the stereo difference value D_{f} where the sub-band direction vector was directed towards the right speaker but where the sub-band direction vector was directed towards the left speaker the ambience component associated with the sub-band has a zero value.

This may be summarised by the following pseudocode.

$${amb}_{f} = \{ \begin{matrix}A , & lCount > rCount \\ B , & otherwise\end{matrix} \\ A = \{ \begin{matrix}{D}_{f} ( j ) , & {θ}_{m} \geq 90 ° \\ 0.0 , & otherwise\end{matrix} , \\ sbOffset [ m ] \leq j < sbOffset [ m + 1 ] \\ B = \{ \begin{matrix}{D}_{f} ( j ) , & {θ}_{m} < 90 ° \\ 0.0 , & otherwise ,\end{matrix}$$

In other words, if the left count is greater than the right count, it uses values A (and uses the difference value) otherwise if right count is equal to or greater than the left count value, it uses value B (which uses the difference value if the difference vector value is less than 90°). In other words, the above removes the ambience components that are on the opposite direction than the dominant audio scene direction. That is to say that if the audio scene direction is on the left channel then the ambience components from the sub-bands are removed that indicate the direction to the right channel and vice versa. In some embodiments it is possible that individual sub-bands may have a different direction from the overall direction.

Where the ambience component determiner 413 has received the indication from the frame mode determiner 411 that the frame is a normal mode, the ambience component determiner 413 may initially cluster the direction vectors of each sub-band to form localised clusters.

The ambience component determiner 413 may therefore start off with a number of clusters equal to the number of sub-bands. Therefore in the example where there are M sub-vectors then the clustering process starts with M clusters with 1 element per cluster. The ambience component determiner 413 may then determine if there are any other sub-band direction vectors within a predefined distance of a known cluster and if so to include them into the cluster. This operation may be repeated with larger and larger predefined cluster distances while the number of cluster is greater than a predetermined cluster threshold. The predetermined cluster threshold may be 5. However it would be appreciated that the predetermined cluster threshold may be more than or less than 5.

Once the clusters threshold has been reached the clusters themselves may be ranked in terms of decreasing order of importance dependent on the coherency of the cluster. In other words how close are the sub-band direction vectors to each other within the cluster.

This clustering and ordering of the clusters may be summarised in the following psuedocode.

/*-- Start with M clusters. --*/
for(i = 0; i < M; i++)
{

nItems[i] = 1; nBandIndices[i][0] = i

}
distRef = 0.01;
Do
{

for(i = 0; i < M; i++)
{

/*-- Calculate radial distance for the cluster. --*/
re = 0.0; im = 0.0
for(j = 0; j < nItems[i]; j++)
{

re += dVecᵣₑ_{_{nBandIndices[i][j]}}; im += dVecᵢₘ_{_{nBandIndices[i][j]}}

}
if(j) re /= j; if(j) im /= j;
/*-- Assign subbands to new cluster based on radial distance.

--*/

for(k = i + 1; k < M; k++)
{

nNew = 0;
for(j = 0; j < nItems[k]; j++)
{

re2 = re − dVecᵣₑ_{_{nBandIndices[i][j]}}; im2 = im −
dVecᵢₘ_{_{nBandIndices[i][j]}}
dist = \sqrt{re2²+im2²}
/*-- This subband needs to be moved to current cluster.

--*/

if(dist < distRef)
{

nIdx[nNew++] = nBandIndices[k][j];

}

}
/*-- Increase subband count in the cluster. --*/
for(j =0; j < nNew; j++)

nBandIndices[i][nItems[i] + j] = nIdx[j];

nItems[i] += nNew;
/*-- Remove subbands from old cluster. --*/
if(nNew)
{

for(j = 0, h = 0; j < nItems[k]; j++)
{

if(nBandIndices[k][j] == nIdx[h])
{

for(y = j; y < nItems[k] − 1; y++)

nBandIndices[k][y] =
nBandIndices[k][y + 1];

h++; j = −1; nItems[k] −= 1;
if(h == nNew)

exit for-loop;

}

}

}

}

}
/*-- Calculate how many clusters currently available. --*/
for(i = 0, audioSceneClusters = 0; i < M; i++)

if(nItems[i]) audioSceneClusters++;

distRef *= 1.005f;

} while(audioSceneClusters > 5);
/*-- Save the result. --*/
for(i = 0, audioSceneClusters = 0; i < M; i++)
{

if(nItems[i])
{

nBandsInCluster[i] = nItems[i];
clusterBands[audioSceneClusters].gainIndex = i;
/*-- Calculate distance for the subbands within the cluster. -

-*/

re = 0.0; im = 0.0;
for(j = 0; j < nItems[i]; j++)
{

re += dVecᵣₑ_{_{nBandIndices[i][j]}}; im += dVecᵢₘ_{_{nBandIndices[i][j]}}

}
if(j) re /= j; if(j) im /= j;
clusterBands[audioSceneClusters++].gainValue = \sqrt{re² +im²}

}

}
Sort clusterBands to decreasing of importance based on the
distance value.

The clustering operation may be further shown with respect to the direction vectors in FIG. 10 where four clusters of direction vectors are shown. The first cluster 1001a has a cluster of three sub-band direction vectors 1003a, 1003b and 1003c Furthermore, a second cluster 100b, a third cluster 1001c, and a fourth cluster 1001d are shown.

The ambience component determiner 413 having clustered the direction vectors of the sub-bands and ordered the clusters then assigns the ambience component values to the sub-bands. The ambience component determiner 413 may assign the stereo component value D_{f} to the more important cluster values but zero or filter the values from the least important cluster sub-band values. For example in the above example where the clustering process clusters the sub-bands into 5 clusters the least important cluster sub-band values are zeroed. This operation may be shown by the following pseudocode. It would be appreciated that more than one cluster sub-band ambience values may be filtered or zeroed in other embodiments of the invention.

amb_{f} =D_{f}
for(i = audioSceneClusters − 1; i < audioSceneClusters; i++)
{

for(j = 0; j < nBandsInCluster[clusterBands[i].gainIndex]; j++)
{

sbIdx = nBandIndices[clusterBands[i].gainIndex][j];
for(k = sbOffset[sbIdx]; k < sbOffset[sbIdx + 1]; k++)

amb_{f}(k)=0.0

}

}

The ambience component determiner 413 then outputs the ambience components to the quantizer 313.

The determination of the ambience components are shown in FIG. 6 in step 613.

Furthermore the process of the analysis of the frame and the determination of the ambience components is shown in FIG. 5 in the step 511.

The quantizer 313, having received the ambience coefficient values from the ambience component determiner 413 performs quantization on the ambience coefficient values and outputs the quantized values to the multiplexer 315. The quantization process used may be any suitable quantization method.

The quantization of the ambience coefficients are shown in step 513 of FIG. 5.

The multiplexer 315 receives the mono encoded signal and the ambience quantized coefficients and outputs the combined signal as the encoded audio bit stream 112.

In some embodiments of the invention the parametric stereo encoder 309 may output stereo parameter values and the ambience analyser 311 output a filtering pattern which may be used to filter the stereo parameter values. These filtered values may then be quantized and passed to the multiplexer 315. Furthermore in other embodiments of the invention quantised stereo parameter values may be passed to the multiplexer from the parametric stereo encoder 309, a filter pattern passed from the ambience analyser 311 and the multiplexer apply the filter pattern to the quantised stereo parameter values.

In some embodiments of the invention there may be implemented a two level encoding process. The first or basic level of stereo encoding would be implemented by the parametric stereo encoder 309 generating a low bit rate stereo parameter bit stream to generate some basic stereo information. This basic stereo information may be quantised and passed to the multiplexer 315. The second or higher level of stereo encoding may be produced by the parametric stereo encoder 309 generating a higher bit rate stereo parameter bit stream representing more refined stereo information. This higher bit rate stereo parameter bit stream would be the information passed to the ambience analyser and modified dependent on the frame mode and the sub-band direction vector information.

Thus by selective application of the stereo parameter values dependent on the ambience analysis the average number of bits to represent an audio signal may be reduced without having an appreciable effect on the audible signal received or decoded. Or on the other hand by not encoding the stereo components of sub-bands enables greater encoding resources to be applied to the parts of the audio signal requiring additional detail because of the results of the ambience analysis.

Furthermore although the above examples show the selection between two modes and the application of rules associated to the mode selected, it would be appreciated that in other embodiments of the invention more than two modes of operation may be determined and furthermore more than two rule sets are applied to the stereo components of the sub-bands. Thus in embodiments of the invention there may be apparatus which determines a mode from a set of modes dependent on parameters determined from the audio signal, and then apply a set of rules to the audio signal to generate an ambience parameter for the audio signal. As indicated above, these mode determination parameters may be determined from a sub-band analysis of the audio signals from each channel. Also in embodiments of the invention the rules may generate the ambience parameter dependent on a previously determined audio signal channel's parameter or parameters. For example in some embodiments as described above the difference parameter between two channel audio signals may be modified dependent on the mode determined and the mode's rules. The modification of the parameters may further be carried out at either the sub-band or individual frequency component level.

To aid the understanding of the invention, and with respect to FIGS. 7 and 8, a decoder according to an embodiment of the invention and the operation of the decoder is shown. In this example the decoder receives a bit stream with mono encoded information, low bit rate stereo information in the stereo bit stream and higher bit rate stereo information in the ambience bit stream. However it would be appreciated that other embodiments of the invention may only receive the mono and ambience information. In such embodiments of the invention the stereo decoder described below may be implemented by copying the mono reconstructed audio signal to both the left reconstructed channel and the right reconstructed channel. Furthermore in embodiments of the invention this operation may be carried out within the ambience decoder and synthesizer 707 and therefore not implement or require the parametric stereo decoder 705.

The decoder 108 receives the encoded bit stream at a demultiplexer 701. This operation is shown in FIG. 1 by step 801.

The demultiplexer 701 having received the encoded bit stream divides the components of the bit stream into individual data stream components. This operation effectively carries out the complementary operation of the multiplexer in the encoder 104.

The demultiplexer 701 may output a mono encoded bit stream to the mono decoder 703, a parametric stereo encoded bit stream to the parametric stereo decoder 705, and ambience coefficient values to the ambience decoder and synthesizer 707. The de-multiplexing operation where the encoded bit stream may be separated into mono/stereo/ambience components is shown in FIG. 8 by step 803.

The mono decoder 703 decodes the mono encoded value to output a mono audio signal in frequency domain components. The decoding process performed is dependent and complimentary to the codec used in the mono encoder 307 of the encoder 104. The mono decoder then outputs the decoded mono audio signal (\tilde{M}_{f}(j)) to the parametric stereo decoder 705.

The decoding of the mono component to generate the decoded mono signal is shown in FIG. 8 by step 805.

The parametric stereo decoder 705 receives the decoded mono audio signal (\tilde{M}_{f} (j)) and the low bit rate parametric stereo components from the de-multiplexer 701 and using these values generates a left channel audio signal and right channel audio signal with some stereo effect. For example where the stereo components are represented by \tilde{D}_{f} the left and right channel audio signals may be generated according to the following equations:

\tilde{L}_{f}(j)=\tilde{M}_{f}(j)+\tilde{D}_{f}

\tilde{R}_{f}(j)=\tilde{M}_{f}(j)−\tilde{D}_{f}.

The output of the parametric stereo decoder 705 may be passed to the ambience decoder and synthesizer 707.

The decoding and application of the stereo component is shown in FIG. 8 by step 807.

The ambience decoder and synthesizer 707 receive the ambience coefficient bit stream from the demultiplexer 108 and the output of the parametric stereo decoder 705. The ambience decoder and synthesizer then apply the ambience coefficients to the left and right channel audio signals to create a more detailed representation of the audio environment. In other words where the parametric stereo decoder is used to create the basic audio scene representation, the ambience decoder and synthesizer is only applied to the spectral samples where a non-zero ambience component is found.

The ambience decoder and synthesizer 707 apply the ambience signal to the mono signal to generate an enhanced left or right channel frequency component. Therefore in embodiments of the invention where there are non-zero ambience coefficients the left and right channel frequency domain values generated in the parametric stereo decoder are replaced using the following equations:

$${\tilde{L}}_{f} ( j ) = {\tilde{M}}_{f} ( j ) + am {\tilde{b}}_{f} ( j )$$

$${\tilde{R}}_{f} ( j ) = {\tilde{M}}_{f} ( j ) - am {\tilde{b}}_{f} ( j ) , \\ sbOffset [ m ] \leq j < sbOffset [ m + 1 ]$$

This may be repeated for all of the sub-bands where there is a non-zero ambience component.

The left channel frequency domain values \tilde{L}_{f}(j) and the right channel frequency domain values \tilde{R}_{f}(j) may then be passed to the left channel inverse transformer 709 and the right channel inverse transformer 711 respectively.

The decoding and application of the ambience component to generate enhanced left and right channel frequency domain values is shown in FIG. 8 by step 809.

The left inverse transformer 709 receives the left channel frequency domain values and inverse transforms them into left channel time domain values. Similarly the right inverse transformer 711 receives the right channel frequency domain values and inversely transforms them to right channel time domain values.

The left and right channel inverse transformers 709 and 711 perform the complementary operation performed by the left channel and right channel time to frequency domain transformers 301 and 303 in the encoder 104. Therefore the inverse transformation applied to convert the frequency domain values into time domain values is the complementary transform to the transform applied in the encoder.

The operation of the inverse transformers is shown in FIG. 8 by step 811.

The output of the left and right channel time domain audio components then effectively represent the reconstructed output audio signal 114 which may contain enhanced stereo detail dependent on the ambience of the original signal to be encoded.

In embodiments of the invention with multiple pairs of channels the method described above may process each pair of channels in parallel. However it would be understood that each channel pair may also be processed serially or partially serially and partially in parallel according to the specific embodiment and the associated cost/benefit analysis of parallel/serial processing.

The embodiments of the invention described above describe the codec in terms of separate encoders 104 and decoders 108 apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some/or all common elements.

Embodiments of the invention configured to receive multiple audio input signals may be particularly advantageous for encoding and decoding audio signals from different sources.

Although the above examples describe embodiments of the invention operating an encoder and decoder operating within a codec within an electronic device 10 or apparatus, it would be appreciated that the invention as described below may be implemented as part of any audio processing stage within a chain of audio processing stages.

Thus user equipment may comprise an encoder and/or decoder such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-28. (canceled)

29. A method comprising:
determining at least one first parameter, wherein the first parameter is based at least in part on a difference between at least two audio signals;
determining at least one direction vector relative to a defined listening position for each of at least one frequency range for a combination of a first and a second of the at least two audio signals;
and
generating at least one ambience coefficient value by: determining that the distribution of all direction vectors is throughout a range from a first predefined direction to a second predefined direction and at least one direction vector is directed generally towards the first predefined direction and a further direction vector is directed generally towards the second predefined direction;
grouping the direction vectors into neighbouring direction vector clusters; and
ranking the clusters based at least in part on the distance between direction vectors in each cluster.

30. The method as claimed in claim 29, wherein determining the first at least one parameter comprises determining at least one of:
an inter channel level difference;
an inter channel time delay; and
an inter channel correlation.

31. The method as claimed in claim 29 wherein the ambience coefficient value associated with at least the highest ranked cluster of direction vectors is equal to an associated first parameter.

32. The method as claimed in claim 29 further comprising:
generating a sum signal of the combined first and second audio signals.

33. The method as claimed in claim 29, further comprising:
generating a stereo signal of the combined first and second audio signals.

34. The method as claimed in claim 33, further comprising:
multiplexing the sum signal, stereo signal and the at least one ambience coefficient.

35. A method comprising:
receiving an encoded audio signal, the audio signal comprising:
at least one mono audio signal value, and at least one ambience coefficient value, wherein the ambience coefficient value represents a distribution of direction vectors throughout a range from a first predefined direction to a second predefined direction and at least one direction vector is directed generally towards the first predefined direction and a further direction vector is directed generally towards the second predefined direction, wherein the at least one direction vector is relative to a defined listening position, wherein the at least one direction vector is a grouped into neighbouring vector clusters, and wherein the vector clusters are ranked based at least in part on a distance between direction vectors in each vector; and
generating a first audio signal wherein the first audio signal is a combination of the mono audio signal value with an associated stereo audio signal value if an associated ambience coefficient value is zero, and a combination of the mono audio signal value with the associated ambience coefficient value if the associated ambience coefficient value is non-zero

36. The method as claimed in claim 35 further comprising:
generating a second audio signal wherein the second audio signal is a difference of the mono audio signal value with an associated stereo audio signal value if an associated ambience coefficient value is zero, and a difference of the mono audio signal value with the associated ambience coefficient value if the associated ambience coefficient value is non-zero.

37. An apparatus comprising at least one processor and at least one memory including computer program code the at least one memory and the computer program code configured to, with the at least one processor, cause the apparatus at least to:
determine at least one first parameter, wherein the first parameter is based at least in part on a difference between at least two audio signals;
determine at least one direction vector relative to a defined listening position for each of at least one frequency range for a combination of a first and a second of the at least two audio signals; and
generate at least one ambience coefficient value by: determining that the distribution of all direction vectors is throughout a range from a first predefined direction to a second predefined direction and at least one direction vector is directed generally towards the first predefined direction and a further direction vector is directed generally towards the second predefined direction;
group the direction vectors into neighbouring direction vector clusters; and
rank the clusters based at least in part on the distance between direction vectors in each cluster.

38. The apparatus as claimed in claim 37, wherein the first at least one parameter comprises:
an inter channel level difference;
an inter channel time delay; and
an inter channel correlation.

39. The apparatus as claimed in claim 37:
wherein the ambience coefficient value associated with at least the highest ranked cluster of direction vectors is equal to an associated first parameter.

40. The apparatus as claimed in claim 37, wherein the at least one memory and the computer program code are further configured to, with the at least one processor, cause the apparatus at least to:
generate a sum signal of the combined first and second audio signals.

41. The apparatus as claimed in claim 37, wherein the at least one memory and the computer program code are further configured to, with the at least one processor, cause the apparatus at least to:
generate a stereo signal of the combined first and second audio signals.

42. The apparatus as claimed in claim 41, wherein the at least one memory and the computer program code are further configured to, with the at least one processor, cause the apparatus at least to:
multiplex the sum signal, stereo signal and the at least one ambience coefficient.

43. An apparatus comprising at least one processor and at least one memory including computer program code the at least one memory and the computer program code configured to, with the at least one processor, cause the apparatus at least to: receive an encoded audio signal, the audio signal comprising: at least one mono audio signal value and at least one ambience coefficient value, wherein the ambience coefficient value represents a distribution of direction vectors throughout a range from a first predefined direction to a second predefined direction and at least one direction vector is directed generally towards the first predefined direction and a further direction vector is directed generally towards the second predefined direction, wherein the at least one direction vector is relative to a defined listening position, wherein the at least one direction vector is a grouped into neighbouring vector clusters, and wherein the vector clusters are ranked based at least in part on a distance between direction vectors in each vector; and
generate a first audio signal wherein the first audio signal is a combination of the mono audio signal value with an associated stereo audio signal value if an associated ambience coefficient value is zero, and a combination of the mono audio signal value with the associated ambience coefficient value if the associated ambience coefficient value is non-zero.

44. The apparatus as claimed in claim 43 wherein the at least one memory and the computer program code are further configured to, with the at least one processor, cause the apparatus at least to:
generate a second audio signal wherein the second audio signal is a difference of the mono audio signal value with an associated stereo audio signal value if an associated ambience coefficient value is zero, and a difference of the mono audio signal value with the associated ambience coefficient value if the associated ambience coefficient value is non-zero.
